(19) United States
(12) Patent Application Publication
(10) Pub. No.: US 2020/0218942 A1
(43) Pub. Date: Jul. 9, 2020

(54) COMPUTER AND IMAGE PROCESSING METHOD

(71) Applicant: Hitachi, Ltd., Tokyo (JP)

(72) Inventors: Masahiro KAGEYAMA, Tokyo (JP); Hanae YOSHIDA, Tokyo (JP); Masahiro OGINO, Tokyo (JP)

(21) Appl. No.: 16/736,847

(22) Filed: Jan. 8, 2020

(30) Foreign Application Priority Data
Jan. 9, 2019 (JP) 2019-001991

(51) Int. Cl. G06K 9/62; G06K 9/42

(52) U.S. Cl. CPC G06K 9/6262; G06K 9/42

(57) ABSTRACT

A computer configured to perform image processing to detect an object from an image, comprising: an arithmetic device; and a storage device coupled to the arithmetic device, having a model information database to store a plurality of pieces of model information, model information defines a model to realize the image processing, and the arithmetic device being configured to: perform an identification process to detect the object from an evaluation image based on each of the plurality of pieces of model information in a case where the evaluation image is input; and integrate a plurality of output results each of which obtained by the identification process based on each of the plurality of pieces of model information, thereby outputting a detection result of the object.

### CLAIM OF PRIORITY

The present application claims priority from Japanese patent application JP 2019-001991 filed on Jan. 9, 2019, the content of which is hereby incorporated by reference into this application.

### BACKGROUND OF THE INVENTION

The present invention relates to image processing using a neural network. In recent years, convolutional neural network (hereinafter referred to as CNN), which is a core technology for deep learning, is used in various fields. CNN is structured so as to include layers constituted of one or more nodes, with the connections between the nodes of the various layers forming a network. Layers included in CNN include at least one layer on which a convolution operation is performed.

In the medical field, for example, CNNs that process CT (computer tomography) images, MRI (magnetic resonance imaging) images, X-ray images, ultrasound images, and the like are used for high accuracy detection of pathologies, automatic measurement of pathologies, generation of reports for pathologies, and the like. Also, CNNs that process images from surveillance cameras, household video cameras, mobile phones, or the like are used to detect a subject such as a person from the image, or recognize text, characters, graphs, figures, and the like from the image.

An object other than the target object may be detected in the processing result of the image using CNN for detecting the object from the image. For example, a technique described in Japanese Patent Application Publication No. 2017-111731 is known as a technique for reducing the detection rate of an erroneous object without reducing the object detection accuracy.

Japanese Patent Application Publication No. 2017-111731 discloses as “An information processing system for classifying verification images by using a supervised image classifier, comprising an image input means for inputting a verification image, a similar image extraction means for extracting an image similar to the verification image input by the image input means, a teacher data generating means for generating teacher data by giving a label to the image extracted by the similar image extraction means, and a learning means for learning the supervised image classifier using the teacher data generated by the teacher data generating means.”.

### SUMMARY OF THE INVENTION

As described in Japanese Patent Application Publication No. 2017-111731, performing the learning process to feed back the erroneous detection results would reduce the detection rate of false objects. However, this requires manual input of the erroneous detection results. In addition, it is possible that the learning process affects the detection accuracy of true objects.

The present invention provides a technology that realizes image processing with higher accuracy in detecting true objects and a lower rate of detecting false objects.

A representative example of the present invention disclosed in this specification is as follows: a computer configured to perform image processing to detect an object from an image, comprises an arithmetic device; and a storage device coupled to the arithmetic device, and has a model information database to store a plurality of pieces of model information, model information defines a model to realize the image processing. The arithmetic device being configured to: perform an identification process to detect the object from an evaluation image based on each of the plurality of pieces of model information in a case where the evaluation image is input; and integrate a plurality of output results each of which obtained by the identification process based on each of the plurality of pieces of model information, thereby outputting a detection result of the object.

According to the present invention, it is possible to realize image processing with higher accuracy in detecting true objects and a lower rate of detecting false objects. Other problems, configurations, and effects than those described above will become apparent in the descriptions of embodiments below.

### BRIEF DESCRIPTION OF THE DRAWINGS

The present invention can be appreciated by the description which follows in conjunction with the following figures, wherein:

FIG. 1 is a diagram illustrating a configuration example of a computer of Embodiment 1;

FIG. 2 is a diagram illustrating the overview of the process performed by the computer of Embodiment 1;

FIGS. 3A and 3B are diagrams illustrating an example of a structure of CNN of Embodiment 1;

FIG. 4 is a flowchart for describing a first data conversion process performed by a learning unit of Embodiment 1;

FIG. 5 is a diagram illustrating a flow of the first data conversion process of Embodiment 1;

FIG. 6 is a flowchart for describing a learning process performed by the learning unit of Embodiment 1;

FIG. 7 is a diagram illustrating a flow of the learning process of Embodiment 1;

FIG. 8 is a flowchart for describing a second data conversion process performed by an image processing unit of Embodiment 1;

FIG. 9 is a flowchart for describing a detection process performed by the image processing unit of Embodiment 1;

FIG. 10 is a diagram illustrating a flow of the second data conversion process and the detection process of Embodiment 1;

FIG. 11 is a flowchart for describing a third data conversion process performed by the image processing unit of Embodiment 1;

FIG. 12 is a flowchart for describing an integration process performed by the image processing unit of Embodiment 1;

FIG. 13 is a diagram illustrating the flow of the third data conversion process and the integration process of Embodiment 1;

FIG. 14 is a diagram illustrating a variation of the flow of the integration process of Embodiment 1;

FIG. 15 is a diagram illustrating a configuration example of logical operators of Embodiment 1;

FIG. 16 is a diagram illustrating a flow of a process performed by the image processing unit of Embodiment 1;

FIG. 17 is a diagram illustrating the flow of the process performed by the image processing unit of Embodiment 1;

FIG. 18 is a flowchart for describing the learning process performed by the learning unit of Embodiment 2;

FIGS. 19A, 19B, 19C, 19D, 19E, 19F, and 19G are diagrams illustrating an example of conversion learning data of Embodiment 2;

FIG. 20 is a flowchart for describing the learning process performed by the learning unit of Embodiment 3;

FIG. 21 is a flowchart for describing the detection process performed by the image processing unit of Embodiment 3; and

FIG. 22 is a diagram illustrating a system configuration example of Embodiment 4.

### DETAILED DESCRIPTION OF EMBODIMENTS

The present invention provides a technology to detect an object using CNN that realizes image processing including a process to detect an object from an image.

Here, the CNN is a network which a plurality of layers constituted of a plurality of nodes are connected as will be described later. A node is an artificial neuron, and is also referred to as a unit.

Embodiments of the present invention will be explained below with reference to the attached drawings. The attached drawings show specific implementation examples based on the principles of the present invention, but the drawings are merely for understanding the present invention and are not to be used to limit the interpretation of the present invention.

In the embodiments, explanations are made in sufficient detail for a person having ordinary skill in the art to implement the present invention, but other implementations and configurations are possible, and it should be noted that it is possible to modify the configuration and structure as well as interchange various elements without departing from the scope and spirit of the technical concept of the present invention. Thus, the following description should not be understood as limiting the interpretation of the present invention.

In the drawings for describing the embodiments, the same components are, as a rule, assigned the same reference characters, and redundant explanations thereof are omitted.

### Embodiment 1

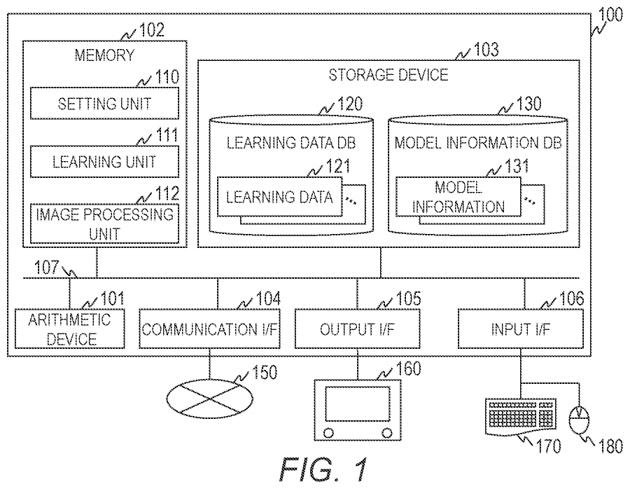

FIG. 1 is a diagram illustrating a configuration example of a computer 100 of Embodiment 1.

A computer 100 includes an arithmetic device 101, a memory 102, a storage device 103, a communication interface 104, an output interface 105, and an input interface 106. The aforementioned pieces of hardware are connected to each other through a bus 107.

The arithmetic device 101 is a device that controls the entire computer 100, and is a CPU (central processing unit), for example. The arithmetic device 101 executes programs stored in the memory 102. The arithmetic device 101 performs processes according to the programs, thereby operating as functional units to realize specific functions. In the description below, when a functional unit is described as performing a process, it in fact signifies that the arithmetic device 101 is executing a program to realize the functional unit.

The memory 102 stores programs to be executed by the arithmetic device 101 and information to be used by the programs. Also, the memory 102 includes a work area to be temporarily used by the programs. The memory 102 stores programs that realize a setting unit 110, a learning unit 111, and an image processing unit 112.

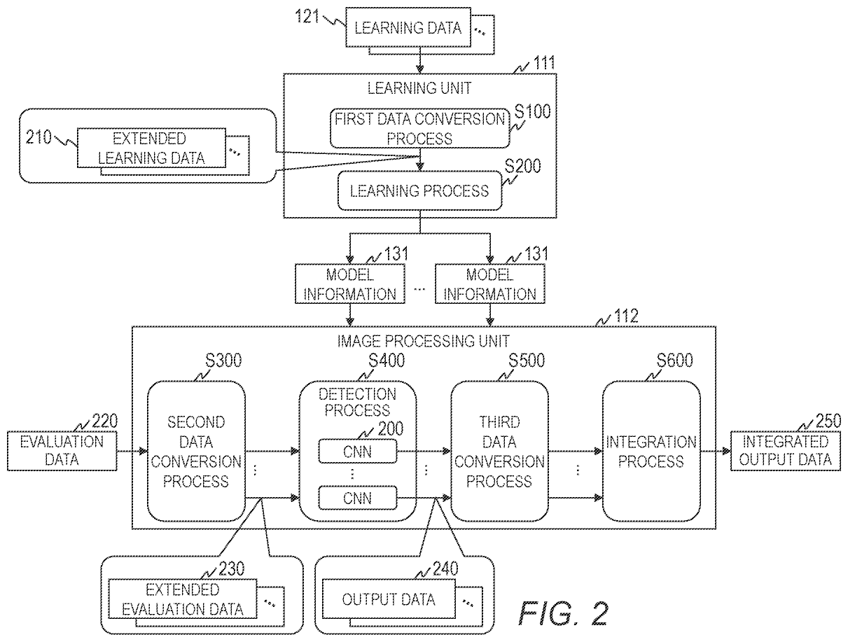

The setting unit 110 constructs a CNN 200 (see FIG. 2) of the learning target. The learning unit 111 performs a learning process for the CNN 200 using learning data 121 stored in the learning data DB 120. The learning unit 111 generates model information 131 which is definition information of the CNN 200 as a learning result, and stores the model information 131 in model information DB 130. The image processing unit 112 uses a plurality of pieces of model information 131 to perform a certain image processing on an inputted image.

The CNN 200 of Embodiment 1 is a model to realize an identification process to detect an object from the image. The image processing unit 112 performs image processing to detect an object from the input image.

The storage device 103 stores data permanently, and is a hard disk drive (HDD) or a solid-state drive (SSD), for example. The storage device 103 stores learning data DB 120 and the model information DB 130.

The learning data DB 120 is a database to store the learning data 121 constituted of input data 500 (see FIG. 5) and supervised data 510 (see FIG. 5). The model information DB 130 is a database to store the model information 131 for managing the structure of the CNN 200. The model information 131 includes hyperparameters, network structures, and the like.

The programs and information stored in the memory 102 may be stored in the storage device 103. In such a case, the arithmetic device 101 reads in the programs and information from the storage device 103, loads the programs and information to the memory 102, and executes the programs loaded to the memory 102.

The communication interface 104 is an interface for communication with an external device such as an image obtaining device through the network 150. The computer 100 transmits and receives various images, information relating to the structure of the CNN 200, commands for controlling the external device, or the like through the communication interface 104.

The network 150 is a local area network (LAN), wide area network (WAN), an intranet, the internet, mobile phone networks, landline networks, and the like. The connection may be wired or wireless. The computer 100 may be directly connected to the external device through the communication interface 104.

The output interface 105 is an interface for connecting to an output device such as a display 160. The display 160 displays various images, information relating to the structure of the CNN 200, the progress of a learning process and image processing, and the like.

The input interface 106 is an interface for connecting to an input device such as a keyboard 170 and a mouse 180. The designer of the CNN 200 (hereinafter referred to as the user) uses the input device to set various values and input various commands.

FIG. 2 is a diagram illustrating the overview of the process performed by the computer 100 of Embodiment 1.

The learning unit 111 performs a first data conversion process to generate extended learning data 210 to be used for learning, using the learning data 121 (Step S100). The first data conversion process is performed to augment the learning data 121.

The learning unit 111 performs the learning process to generate a plurality of pieces of model information 131, using a plurality of pieces of extended learning data 210 (Step S200). As a result, a plurality of pieces of model information 131 is generated.

The image processing unit 112 performs a second data conversion process to generate extended evaluation data 230 in a case of inputting evaluation data 220 (Step S300). The extended evaluation data 230 is input into the CNN 200 defined by the model information 131. The second data conversion process is performed to augment the evaluation data 220.

The image processing unit 112 performs a detection process to detect objects on the plurality of pieces of extended evaluation data 230 (Step S400). In the detection process, the identification processes by using the plurality of CNNs 200 are performed in parallel or in sequence. Each CNN 200 then generates output data 240 including the detection results of the objects.

The image processing unit 112 performs a third data conversion process on a plurality of pieces of output data 240 (Step S500), and performs an integration process using the plurality of pieces of output data 240 performed the third data conversion process (Step S600). As described below, in the integration process, a logical operation such as logical sum and logical product is performed.

The CNN 200 corresponding to each model information 131 is generated using extended learning data 210 generated from the same learning data 121. Thus, in the identification process based on each CNN 200, the true objects are detected in the same positions in the image (extended evaluation data 230). On the other hand, false objects are detected at random positions in the image (extended evaluation data 230). Therefore, by performing the logic operation on the plurality of pieces of output data 240 each of which output from one of the plurality of CNNs 200, false objects are removed, and true objects can be detected with a high degree of accuracy.

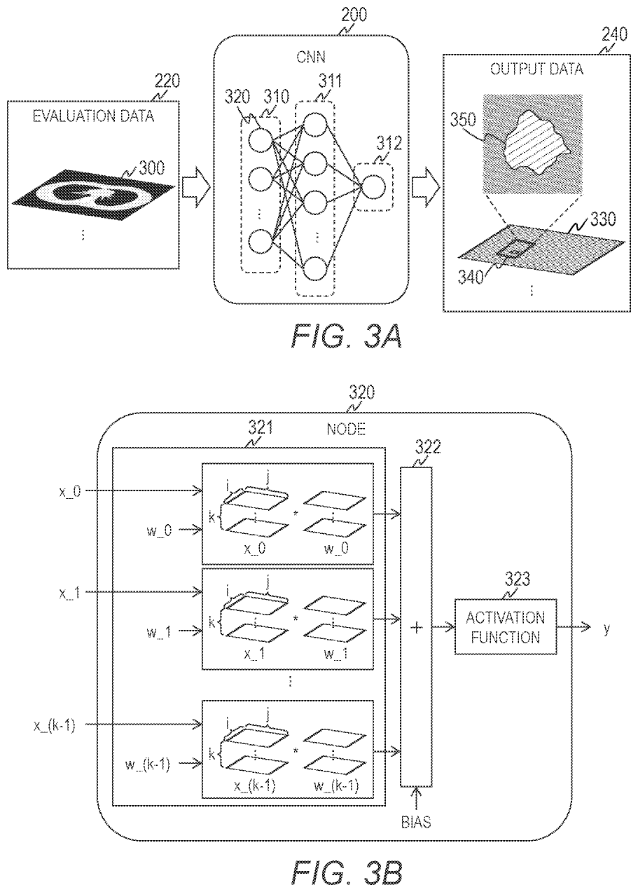

FIGS. 3A and 3B are diagrams illustrating an example of a structure of the CNN 200 of Embodiment 1.

In Embodiment 1, a lung cancer CAD (computer-aided detection/diagnosis) system that employs image processing using the CNN 200 will be described as an example.

This CAD system executes image processing in order to automatically or semi-automatically detect a pathology, identify whether a pathology is normal or abnormal, perform size measurement, distinguish among types of pathologies, or the like. In this system, the CAD analyzes volume data concurrently with a plurality of physicians interpreting the volume data, and presents analysis results to the physicians. As a result, overlooking of pathologies can be prevented.

The image processing unit 112 receives, as evaluation data 220, a computed tomographic image of the chest (volume data) captured by a CT apparatus or the like. The evaluation data 220 include a plurality of evaluation slice images 300 that constitute the computed tomographic images of the chest. The image processing unit 112 performs image processing to detect a nodule in the evaluation slice images 300, and outputs output data 240 including output slice images 330 indicating the position of the nodule in the evaluation slice images 300.

From an evaluation slice image 300 including a nodule, an output slice image 330 including ROI (region of interest) 350 at the position corresponding to the nodule is output. In FIG. 3A, the output slice image 330 where the ROI 350 is located in a rectangular area 340 is output. The rectangular area 340 is added for ease of explanation, and is not displayed in an actual image.

In the descriptions below, ROI 350 corresponding to a nodule is TP-ROI (true positive-region of interest) 351, and ROI 350 corresponding to an object that is not a nodule is FP-ROI (false positive-region of interest) 352.

The output slice image 330 of Embodiment 1 is output as a binarized image. Specifically, the image is set such that the ROI 350 is white (luminance value of 1), and remaining portions are black (luminance value of 0). The output slice image 330 need not be binarized. For example, the image may be one in which the luminance value is changed in a continuous fashion according to the probability of a given section being a nodule. In this case, one possible display method is one in which if the probability of a given section being a nodule is high, the luminance is set to be high, and if the probability of being a nodule is low, then the luminance is set to be low.

The structure of the CNN 200 that realizes the aforementioned image processing will be explained.

The CNN 200 of Embodiment 1 is constituted of three layers. The first layer is a boundary detection layer 310, the second layer is a movement layer 311, and the third layer is a coupling layer 312. Each of the layers 310, 311, and 312 is constituted of at least one node 320. The structure of the node 320 will be described with reference to FIG. 3B.

The node 320 is constituted of a convolution operation 321, an adding operation 322, and an activation function 323.

In the convolution operation 321, a three-dimensional convolution operation is performed on an input pixel group x_a, which is constituted of n-number of three-dimensional blocks having k-number of slice images with i-number of pixels in the horizonal direction and j-number of pixels in the vertical direction. Here, n is an integer, and the additional character a is an integer from 0 to (k−1). The three-dimensional convolution operation is performed by preparing k-number of weighting coefficients of the same size as that of the three-dimensional block, and multiplying each pixel in the block by a corresponding coefficient, and calculating the sum of the resulting values.

In the adding operation 322, a bias is added to the result of the convolution operation 321.

The activation function 323 calculates an output y of one pixel on the basis of the value input from the adding operation 322. A rectified linear unit (ReLU), a clipped ReLU, a leaky ReLU, a sigmoid function, a step function, a hyperbolic tangent (tanh) function, or the like is used as the activation function 323, for example.

By performing the three-dimensional block process described above on all pixels of the evaluation data 220, a three-dimensional image can be obtained.

A process by which the horizontal, vertical, and slicing edges are padded such that the size of the integrated output data 250 matches the size of the evaluation data 220.

A CNN 200 that detects people, animals, automobiles, two-wheeled vehicles, abandoned items, dangerous items, and the like can be realized by a similar structure. The input image may be a still image or a video.

Next, the boundary detection layer 310, the movement layer 311, and the coupling layer 312 included in the CNN 200 will be described.

The boundary detection layer 310 detects a boundary corresponding to the contour of an object. If the evaluation data 220 includes a nodule, output data 240 including ROI 350 that is in a three-dimensional shape similar to that of the nodule is output.

The movement layer 311 detects a nodule of a given shape based on the boundary of the object detected by the boundary detection layer 310.

In the movement layer 311, a convolution operation is performed to move the boundary of the object to a reference point on the image and add a value corresponding to the boundary. The reference point is an arbitrarily set point, and in this example, is a “point in the approximate center of a nodule”.

The coupling layer 312 calculates the total of the values of boundaries moved to the reference point, and outputs the detection results of the ROI 350. Specifically, in the node 320 of the coupling layer 312, an operation to calculate the sum of values obtained by multiplying the output of the movement layer 311 by coefficients is performed. That is, the coupling layer 312 is constituted of one node 320 which receives the output of each node of the movement layer 311, and performs a convolution operation on one (1×1) pixel.

The CNN 200 of Embodiment 1 has the following characteristics. In the boundary detection layer 310, a positive value is output from the boundary of the nodule, and in portions other than the boundary, zero is output. Thus, as a result of moving the boundary to the reference point and adding the value of the boundary, a very large positive value is output at the reference point, and zero or a small value is output at points other than the reference points. Therefore, when the boundary detection layer 310 detects M-types of boundary lines, and the movement layer 311 performs a convolution operation for moving the boundary lines in N-number of directions, the CNN 200 can detect nodules of a fixed shape by the combination of (M×N) number of boundaries. That is, the CNN 200 functions as a detector that can detect objects of a given shape.

Next, the process performed by the learning unit 111 for constructing the CNN 200 will be explained.

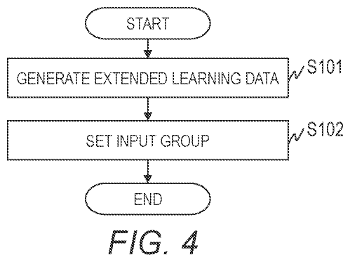

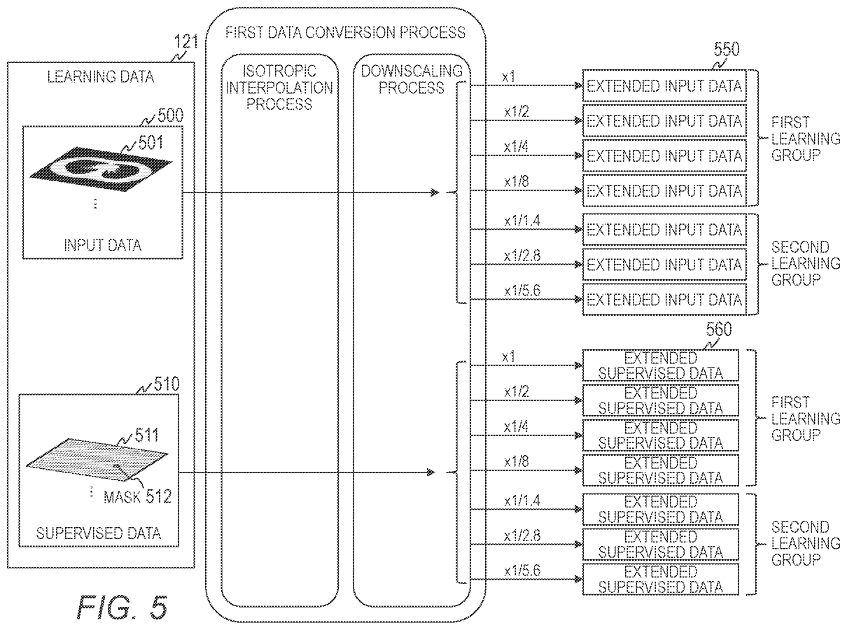

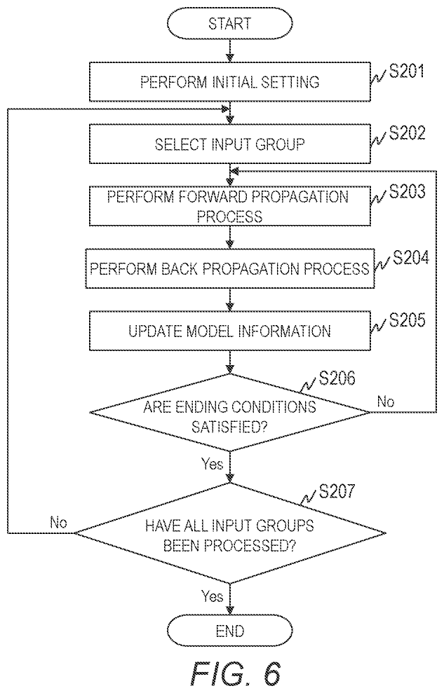

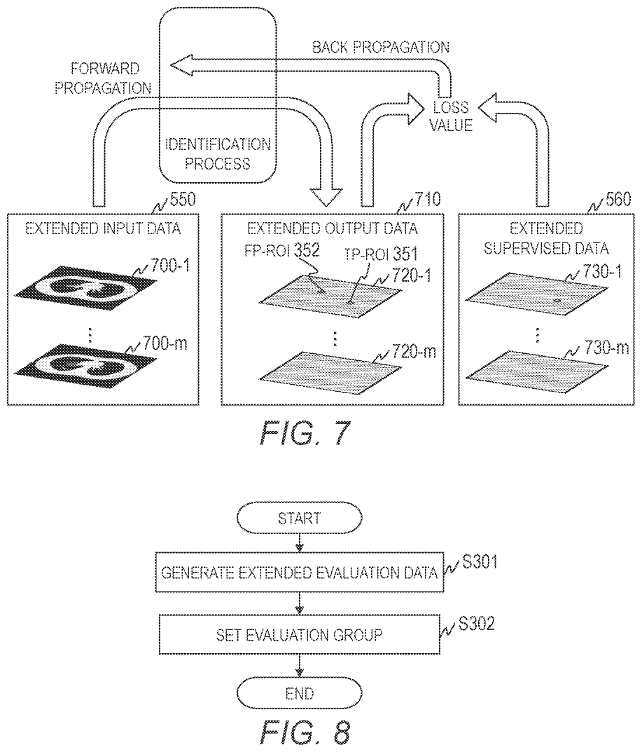

FIG. 4 is a flowchart for describing the first data conversion process performed by the learning unit 111 of Embodiment 1. FIG. 5 is a diagram illustrating a flow of the first data conversion process of Embodiment 1. FIG. 6 is a flowchart for describing the learning process performed by the learning unit 111 of Embodiment 1. FIG. 7 is a diagram illustrating a flow of the learning process of Embodiment 1.

The learning data 121 of Embodiment 1 is constituted of input data 500, which is volume data, and supervised data 510, which is also volume data. The input data 500 includes a plurality of two-dimensional (xy plane) input slice images 501 arranged along the axis (z-axis) perpendicular to the xy plane. The supervised data 510 includes a plurality of two-dimensional (xy plane) supervised slice images 511 arranged along the axis (z-axis) perpendicular to the xy plane.

The input data 500 includes at least one input slice image 501 that has a nodule therein. The supervised slice image 511 corresponding to the input slice image 501 including the nodule includes a mask 512 corresponding to ROI 350.

First, the first data conversion process will be explained. The learning unit 111 reads out the learning data 121 from the learning data DB 120, and generates the extended learning data 210 (Step S101). Specifically, the process described below is performed.

(Process A1) The learning unit 111 performs an isotropic interpolation process on the input data 500 and the supervised data 510 included in one piece of learning data 121. When the interval between the input slice images 501 is larger than the interval between the pixels of the input slice image 501, or when the interval between the supervised slice images 511 is larger than the interval between the pixels of the supervised slice image 511, the isotropic interpolation process (poly-phase filter process between slices) for performing interpolation for the input slice image 501 and the supervised slice image 511 is performed to make the interval between the pixel and the interval between the slice images 511 uniform.

(Process A2) The learning unit 111 performs a downscaling process on the input data 500 including the input slice images 501 and the interpolated input slice images 501, and generates a plurality of extended slice images of difference sizes (extended input data 550 and extended supervised data 560).

The isotropic interpolation need not be performed. The descriptions above are for the process of Step S101.

Next, the learning unit 111 sets input groups in accordance with the downscaling ratio, and classifies the extended learning data 210 into the respective input groups (Step S102). Then, the learning unit 111 ends the first data conversion process, and starts the learning process.

The learning unit 111 performs initial setting to construct an initial CNN 200 (Step S201). This way, model information 131 that defines the structure of pre-learning CNN 200 is generated.

Next, the learning unit 111 selects a target input group (Step S202), and performs a forward propagation process, using the extended learning data 210 included in the target input group (Step S203). The forward propagation process is a process in which the input data propagates through the network such as CNN, thereby generating output results. Specifically, the process described below is performed.

(Process B1) The learning unit 111 measures the size of the nodule included in the extended input data 550, and selects the extended input data 550 in which the size of the nodule is within a prescribed range. The learning unit 111 inputs the extended learning data 210 constituted of the selected extended input data 550 and the extended supervised data 560 corresponding to the selected extended input data 550 into the image processing unit 112.

(Process B2) The image processing unit 112 processes the extended input slice image 700 included in the extended input data 550 based on the model information 131, thereby generating extended output data 710 constituted of the extended output slice image 720. In a case where the extended input slice image 700 with a nodule appearing therein is input, then the extended output slice image 720 including the ROI 350 is generated.

(Process B1) and (Process B2) may be performed a prescribed number of times. The description of the forward propagation process is concluded here.

Next, the learning unit 111 performs a back propagation process (Step S204). The back propagation process refers to a process in which the update results of parameters of each layer of the network such as CNN are propagated from the output side to the input side, thereby updating the parameters in all layers. Specifically, the process described below is performed.

The learning unit 111 calculates a loss value that evaluates the degree of error between the extended output data 710 and the extended learning data 210. The learning unit 111 updates parameters such as weighting coefficients of each layer and the bias from the output side to the input side of the CNN 200 on the basis of the loss value.

Algorithms for updating the parameter in a multidimensional space, in which the number of dimensions is the total number of parameters, include gradient descent, stochastic gradient descent (SGD), momentum SDG, Adam Adagrad, AdaDelta, RMProp, SMORMS3, and the like. In Embodiment 1, the algorithm is not limited to being an optimizer. In a case of using gradient descent, the learning unit 111 calculates the gradient, which indicates the direction in which and the degree to which the error is reduced, and updates the parameters on the basis of the gradient for each round of learning.

The explanation of the back propagation process is concluded here.

Next, the learning unit 111 updates the model information 131 based on the results of the back propagation process (Step S205).

The learning unit 111 then determines whether the ending conditions are satisfied or not (Step S206).

For example, the learning unit 111 determines that the ending conditions have been satisfied in a case where the update number (generation number) of the model information 131 is greater than a prescribed threshold. Also, the learning unit 111 determines that the ending conditions have been satisfied in a case where the loss value is equal to or smaller than a prescribed threshold.

In a case where the ending conditions are determined not to have been satisfied, then the learning unit 111 returns to Step S203, and repeats the same process.

In a case where the ending conditions are determined to have been satisfied, then the learning unit 111 determines whether all of the input groups have been processed or not (Step S207).

In a case where the process is determined to not have been performed for all of the input groups, then the learning unit 111 returns to Step S202, and repeats the same process.

In a case where all of the input groups are determined to have been processed, the learning unit 111 ends the learning process.

Below, the downscaling ratio and input groups will be explained using specific examples. In Embodiment 1, the CNN 200 to detect a nodule was generated using the chest CT image database provided by the NCI (national cancer institute) (see Armato S G III, McLennan G, Bidaut L, McNiff-Gray M F, Meyer C R, Reeves A P, Zhao B, Aberle D R, Henschke C I, Hoffman E A, Kazerooni E A, MacMahon H, van Beek E J R, Yankelevitz D, et al.: The Lung Image Database Consortium (LIDO) and Image Database Resource Initiative (IDRI): A completed reference database of lung nodules on CT scans. Medical Physics, 38: 915-931, 2011). This database stores the data for 1018 cases (learning data 121) constituted of volume data (input data 500) and doctors' findings (supervised data 510). Below, the data stored in the database will also be referred to as test data.

As a result of analyzing the test data, the longer diameter of each nodule included in the test data was ranging from 5.4 pixels to 76.7 pixels. In a case where the size range of the objects to be detected is great, it is difficult to improve the detection accuracy of the object.

Therefore, the longer diameters of the nodules are classified into sections of “5 pixels to 10 pixels”, “7 pixels to 14 pixels”, “10 pixels to 20 pixels”, “14 pixels to 28 pixels”, “20 pixels to 40 pixels”, “28 pixels to 56 pixels”, “40 pixels to 80 pixels”, for example, and the downscaling ratio is set such that the longer diameters of the nodules belonging to the respective sections stay within 5 pixels to 10 pixels. The present invention, however, is not limited to those pixel numbers or downscaling ratios.

That is, in Embodiment 1, the learning unit 111 downscales the input data 500 and the supervised data 510 to 1/1 scale, 1/1.4 scale, 1/2 scale, 1/2.8 scale, 1/4 scale, 1/5.6 scale, and 1/8 scale, thereby generating the extended input data 550 and the extended supervised data 560. That is, seven pieces of extended learning data 210 are generated from one piece of learning data 121. The present invention, however, is not limited to those downscaling ratios.

Also, for example, the learning unit 111 groups together “5 pixels to 10 pixels”, “10 pixels to 20 pixels”, “20 pixels to 40 pixels”, and “40 pixels to 80 pixels” into one group (first learning group), and groups together “7 pixels to 14 pixels”, “14 pixels to 28 pixels”, and “28 pixels to 56 pixels” into one group (second learning group). The present invention, however, is not limited to those pixel numbers.

The learning unit 111 performs the learning process using the extended learning data 210 included in the first learning group, and performs the learning process using the extended learning data 210 included in the second learning group.

Through the learning processes using the images downscaled to the respective pixel numbers described above as an example, two CNNs 200 to detect the nodules between 5 pixels and 10 pixels are generated. Those two CNNs 200 generated in a manner described above function as a detector to detect nodules of different sizes.

The sizes of the nodules to be detected by the two CNNs 200 are configured to overlap with each other. In a case where there is a margin of 2 to 3 pixels in the size of nodules that can be detected, the output data 240 obtained from the two CNNs 200 both includes TP-ROI 351 indicating a nodule at the same position. Thus, by integrating two pieces of output data 240, a nodule can be detected at a high degree of accuracy.

On the other hand, because FP-ROI 352 indicating false objects occur at random positions, the locations of the FP-ROI 352 detected by the two CNN 200 are expected to differ. Thus, by integrating two pieces of output data 240, FP-ROI 352 can be removed efficiently.

Next, the process performed by the image processing unit 112 will be explained.

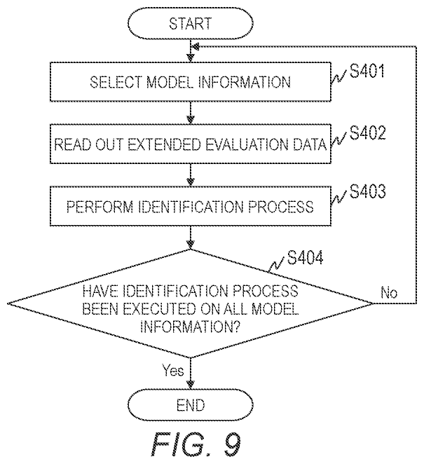

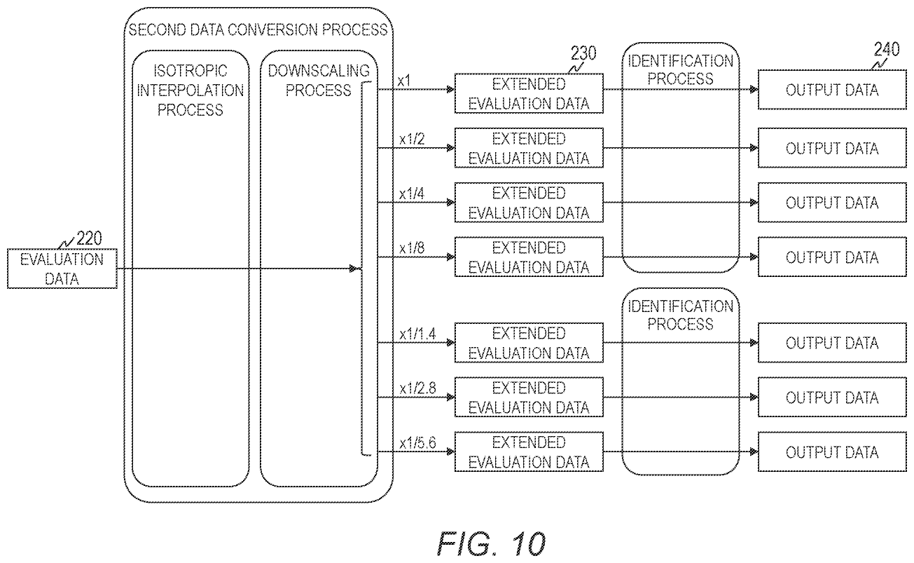

FIG. 8 is a flowchart for describing the second data conversion process performed by the image processing unit 112 of Embodiment 1. FIG. 9 is a flowchart for describing the detection process performed by the image processing unit 112 of Embodiment 1. FIG. 10 is a diagram illustrating a flow of the second data conversion process and the detection process of Embodiment 1.

First, the second data conversion process will be explained. The image processing unit 112 performs the isotropic interpolation process and the downscaling process on the evaluation data 220, thereby generating the extended evaluation data 230 (Step S301).

This isotropic interpolation process is the same as the process performed in the first data conversion process. Also, this downscaling process is the same as the process performed in the first data conversion process. That is, the image processing unit 112 generates seven pieces of extended evaluation data 230 from one piece of evaluation data 220. The isotropic interpolation process need not be performed.

Next, the image processing unit 112 sets evaluation groups in accordance with the downscaling ratio, and classifies the extended evaluation data 230 into the respective evaluation groups (Step S302). Then, the image processing unit 112 ends the second data conversion process, and starts the detection process.

The image processing unit 112 selects target model information 131 from the model information DB 130 (Step S401).

Next, the image processing unit 112 identifies the evaluation group corresponding to the target model information 131, and obtains the extended evaluation data 230 included in the identified evaluation group (Step S402).

Next, the image processing unit 112 performs the identification process on the extended evaluation data 230 based on the target model information 131 (Step S403). As a result, the output data 240 is generated. Although the size of the nodules included in the evaluation data 220 is unknown, by inputting the extended evaluation data 230 of difference sizes into the CNN 200, it is possible to detect nodules of a given size.

Next, the image processing unit 112 determines whether the identification process corresponding to all the model information 131 stored in the model information DB 130 has been completed or not (Step S404).

In a case where the identification process for all of the model information 131 stored in the model information DB 130 has not been completed, the image processing unit 112 returns to Step S401, and repeats the same process. In a case where the identification process for all of the model information 131 stored in the model information DB 130 has been completed, the image processing unit 112 ends the detection process.

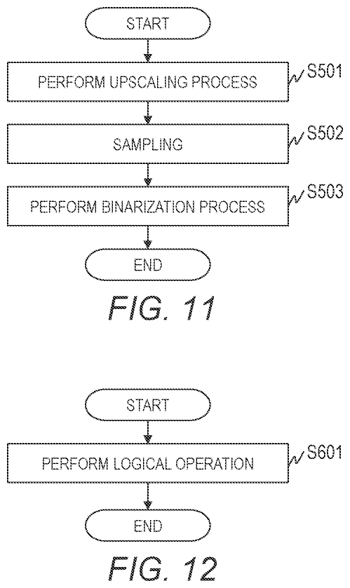

FIG. 11 is a flowchart for describing the third data conversion process performed by the image processing unit 112 of Embodiment 1. FIG. 12 is a flowchart for describing the integration process performed by the image processing unit 112 of

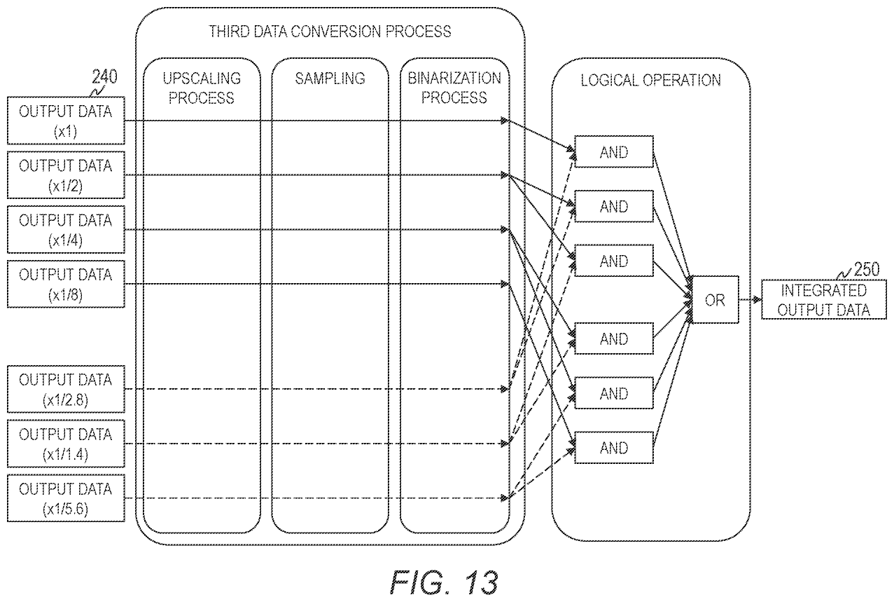

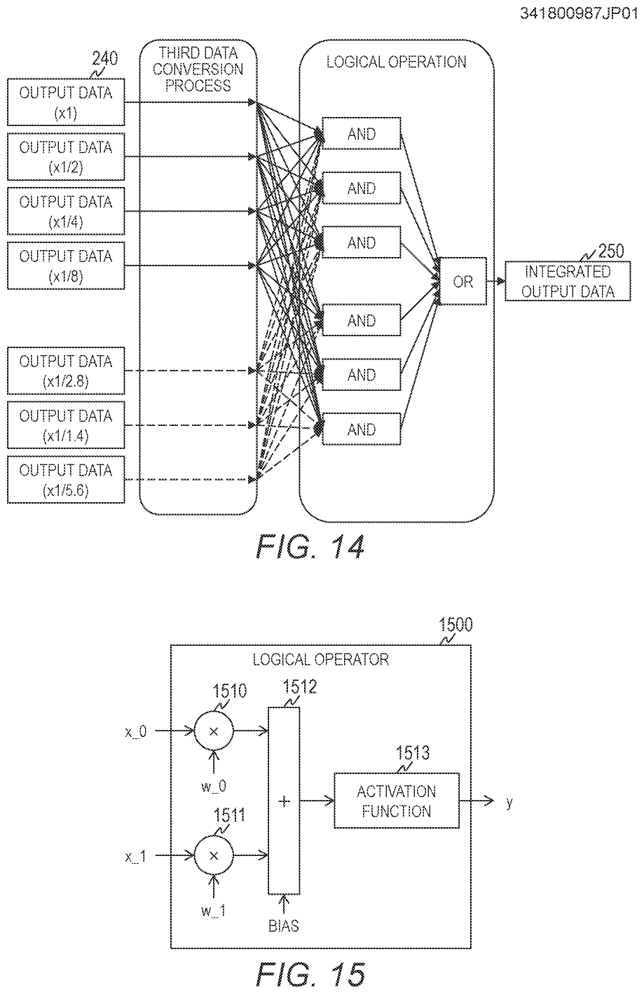

Embodiment 1. FIG. 13 is a diagram illustrating a flow of the third data conversion process and the integration process of Embodiment 1. FIG. 14 is a diagram illustrating a variation of the flow of the integration process of Embodiment 1. FIG. 15 is a diagram illustrating a configuration example of logical operators of Embodiment 1.

The image processing unit 112 performs an upscaling process of the output data 240 output from each CNN 200 (Step S501).

The upscaling ratio of the output data 240 is determined based on the downscaling ratio of the extended evaluation data 230 input into the CNN 200 that has output the output data 240. Specifically, the upscaling ratio is set such that the product of the upscaling ratio and downscaling ratio is 1.

Next, the image processing unit 112 performs sampling on the output data 240 that has gone through the upscaling process (Step S502).

Specifically, the image processing unit 112 deletes the slice images added in the isotropic interpolation process such that the data size of the output data 240 (number of slice images) equals to the data size of the evaluation data (number of slice images). In this process, the image processing unit 112 may also perform a slice interpolation process (poly-phase filtering process between slices), not only simply delete the slice images. Below, this slice interpolation process will also be referred to as sampling. In a case where the isotropic interpolation process has not been performed, this sampling need not be performed.

Next, the image processing unit 112 performs the binarization process to change the output data 240, which has gone through the sampling, to binarized images (Step S503), and then ends the third data conversion process.

Specifically, the image processing unit 112 binarizes the images such that the nodules in the images are shown in white or black. In Embodiment 1, the images are binarized such that the nodules are shown in white (luminance value of 1). The binarization process need not be performed.

Next, the image processing unit 112 performs a logical operation to integrate the plurality of pieces of output data 240 that have gone through the third data conversion process, thereby generating the integrated output data 250 (Step S601). Thereafter, the image processing unit 112 ends the integration process.

In Embodiment 1, as illustrated in FIG. 13, the image processing unit 112 makes pairs of the output data 240 from the smaller to larger downscaling ratio, and performs the logical product operation on each pair of the output data 240 performed the third data conversion process to generate first output data. Furthermore, the image processing unit 112 performs a logical sum operation on each pair of the first output data, thereby generating the integrated output data 250.

The logical operation illustrated in FIG. 13 is one example, and the present invention is not limited to this. For example, the logical operation illustrated in FIG. 14 may be performed.

The logical product and the logical sum can be realized using the logical operator 1500 illustrated in FIG. 15. The logical operator 1500 includes two multipliers 1510, 1511, an adder 1512, and an activation function 1513.

In a case where an input value x_0 and input value x_1 are input into the logical operator 1500, the multiplier 1510 calculates the product of the weight w_0 and the input value x_0, and the multiplier 1511 calculates the product of the weight w_1 and the input value x_1. The adder 1512 adds a bias to the values obtained by the multipliers 1510 and 1511. The activation function 1513 outputs a value based on the value obtained by the adder 1512.

In order to realize the logical product, the weight w_0 and weight w_1 are set to 0.3, the bias is set to 0, and the activation function 1513 is configured to output an output value of “1” if the value calculated by the adder 1512 is greater than 0.5, and output an output value of “0” in any other cases. The logical operator 1500 configured as described above outputs an output value of 1, if the pixels of the image with the downscaling ratio being k and the pixels of the image with the downscaling ratio being k have the luminance value of 1, respectively. That is, if the ROI 350 is present in the pixels of the same position between the two images, the first output data includes the ROI 350 that indicates a nodule. This makes it possible to efficiently remove FP-ROI 352.

If three or more input values are inputted into the logical operator 1500, the output value becomes 1 only when all of the input values are 1.

In order to realize the logical sum, the weight w_0 and weight w_1 are set to 0.7, the bias is set to 0, and the activation function 1513 is configured to output “1” as the output value if the value calculated by the adder 1512 is greater than 0.5, and output “0” as the output value in any other cases. The logical operator 1500 configured as described above outputs 1 as the output value if either the pixels of the image with the downscaling ratio being k or the pixels of the image with the downscaling ratio being k have the luminance value of 1. That is, the output data where each image includes the ROI 350 is generated. This makes it possible to present output data that includes detection results of the nodules of various sizes.

If three or more input values are inputted into the logical operator 1500, the output value becomes 1 if one of the input values is 1.

As described above, the computer 100 integrates the results output from a plurality of CNNs 200 that have input the evaluation data 220, which makes it possible to realize image processing with a higher detection accuracy for TP-ROI 351 and a lower detection rate for FP-ROI 352.

### MODIFICATION EXAMPLE 1

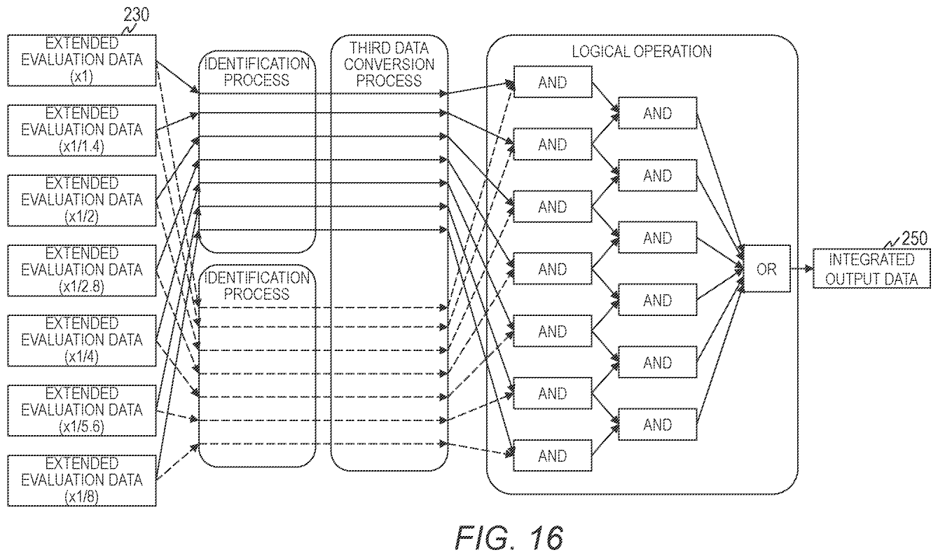

FIG. 16 is a diagram illustrating the flow of the process performed by the image processing unit 112 of Embodiment 1.

The image processing unit 112 inputs all of the extended evaluation data 230 into each CNN 200. The image processing unit 112 performs the logical product operation on the identification result of the extended evaluation data 230 of the same downscaling ratio, thereby calculating the second output data. The image processing unit 112 makes pairs of output data 240 from the smaller downscaling ratio to the larger downscaling ratio, and performs the logical product operation on each pair of the second output data, thereby calculating the third output data. Furthermore, the image processing unit 112 performs the logical sum operation on each pair of the third output data, thereby generating the integrated output data 250.

### MODIFICATION EXAMPLE 2

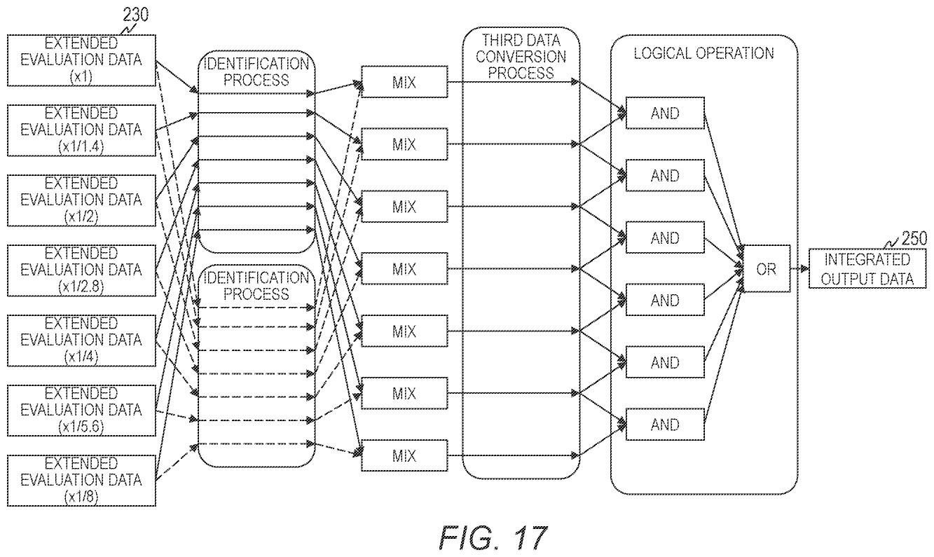

FIG. 17 is a diagram illustrating the flow of the process performed by the image processing unit 112 of Embodiment 1.

The image processing unit 112 inputs all of the extended evaluation data 230 into each CNN 200. The image processing unit 112 mixes together the identification results of the extended evaluation data 230 of the same downscaling ratio. In a case where there are two CNNs 200, the process based on Formula (1) is performed:

Formula 1

k₁y₁+(1−k₁)y₂ (1)

In this formula, y1 and y2 indicate the feature amount of the pixels of the image output from the CNN 200. k1 indicates a coefficient. In a case where k1 is 1, y1 is output, and in a case where k1 is 1/2, then the average value of y1 and y2 is output.

The image processing unit 112 makes pairs of output data 240 from the smaller downscaling ratio to the larger downscaling ratio, and performs the logical product operation on the mixed outputs of each pair, thereby calculating the fourth output data. Furthermore, the image processing unit 112 performs the logical sum operation on each pair of the fourth output data, thereby generating the integrated output data 250.

### Embodiment 2

Embodiment 2 is characterized by the learning data 121 used for the learning process. Embodiment 2 will be explained below mainly focusing on the differences from Embodiment 1.

The configuration of the computer 100 of Embodiment 2 is the same as that of Embodiment 1, and therefore, the explanation is omitted. The first data conversion process performed by the learning unit 111 of Embodiment 2 is the same as that of Embodiment 1, and therefore, the explanation is omitted. The second data conversion process, the detection process, the third data conversion process, and the integration process performed by the image processing unit 112 are the same as those of Embodiment 1, and therefore, the explanation is omitted. The configuration of the CNN 200 of Embodiment 2 is the same as that of Embodiment 1, and therefore, the explanation is omitted.

Embodiment 2 differs from Embodiment 1 in the learning process performed by the learning unit 111.

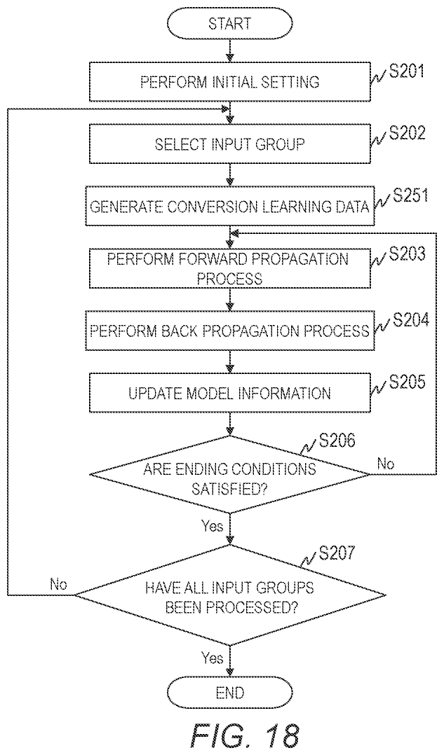

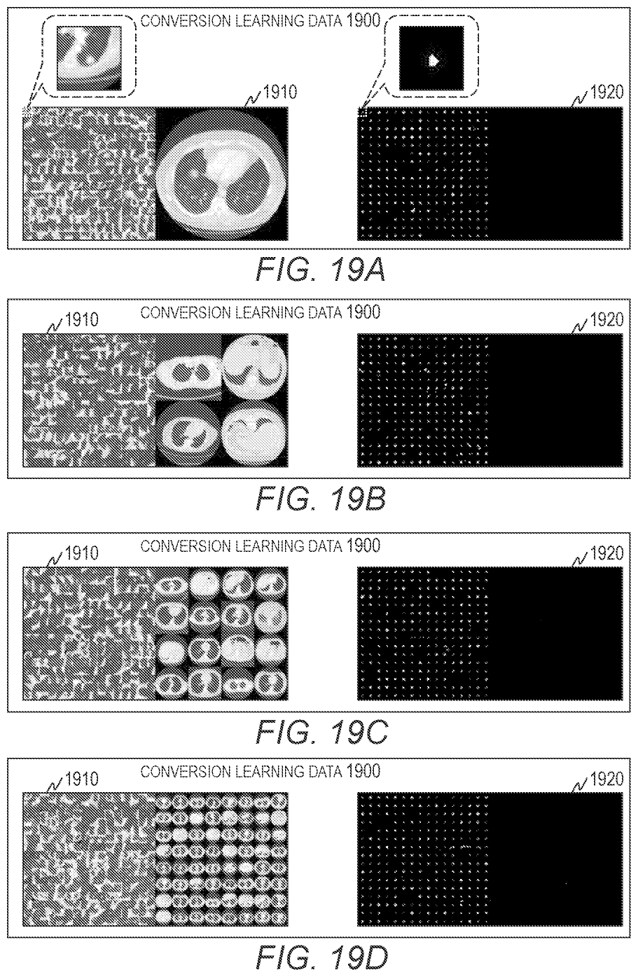

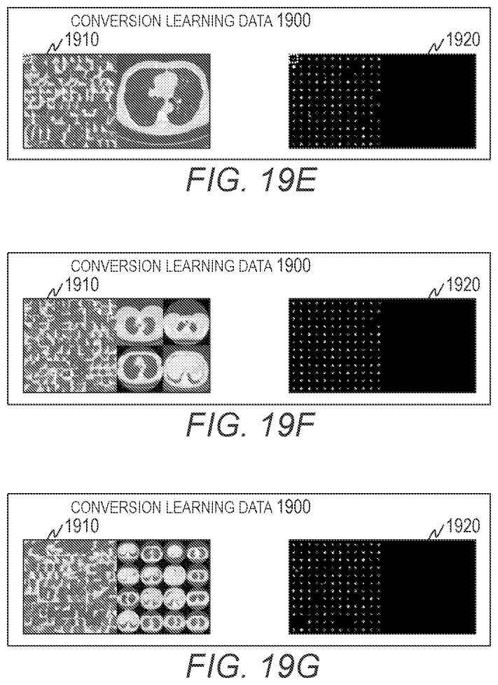

FIG. 18 is a flowchart for describing the learning process performed by the learning unit 111 of Embodiment 2. FIGS. 19A, 19B, 19C, 19D, 19E, 19F, and 19G are diagrams illustrating an example of conversion learning data 1900 of Embodiment 2.

In Embodiment 2, the learning unit 111 selects an input group (Step S202), and generates conversion learning data 1900 constituted of conversion input data 1910 and conversion supervised data 1920 from the extended learning data 210 (Step S251). The conversion learning data 1900 is learning data in which the data length, data format, and the like are adjusted to realize an efficient learning process. Specifically, the processes described below are performed.

The learning unit 111 selects, from the extended learning data 210 included in the input group, a prescribed number of extended learning data 210 (first extended learning data) including nodules of the size ranging from 5 pixels to 10 pixels. The learning unit 111 also selects, from the extended learning data 210 included in the input group, a prescribed number of extended learning data 210 (second extended learning data). It is preferable that the extended learning data 210 that does not include a nodule be selected for the second extended learning data, but the extended learning data 210 that includes a nodule may be selected for the second extended learning data.

The learning unit 111 generates the conversion learning data 1900 including slice images of a given data size from the first extended learning data and the second extended learning data. The data size is set for each of the learning data groups.

Below, the specific method to generate the conversion learning data 1900 will be explained with reference to FIGS. 19A to 19G.

The conversion input data 1910 and the conversion supervised data 1920 of the conversion learning data 1900 included in the first learning group each include 32 slice images having 1024 pixels in the horizontal direction and 512 pixels in the vertical direction, for example. The conversion input data 1910 and the conversion supervised data 1920 of the conversion learning data 1900 included in the second learning group each include 30 slice images having 720 pixels in the horizontal direction and 360 pixels in the vertical direction, for example. The present invention, however, is not limited to those pixel numbers.

The right data area of the conversion input data 1910 has images used for learning tissues other than nodules, and the left data area of the conversion input data 1910 has images used for learning nodules.

The learning unit 111 sets the extended input data 550 of the second extended learning data in the right data area of the conversion input data 1910. The learning unit 111 sets the extended supervised data 560 of the second extended learning data in the right data area of the conversion supervised data 1920. The learning unit 111 may also downscale the extended input data 550 as necessary.

The learning unit 111 cuts out partial input images of a prescribed size that include a nodule from the extended input data 550 of the first extended learning data, and sets the partial input images in the left data area of the conversion input data 1910. The learning unit 111 cuts out partial supervised images of a prescribed size that includes ROI 350 of the extended supervised data 560 of the first extended learning data, and sets the partial supervised images in the left data area of the conversion supervised data 1920.

In Embodiment 1, partial input images and partial supervised images of the size of 32×32 are cut out from the first extended learning data selected from the first learning group, for example. Thus, the number of the partial input images and partial supervised images set in the conversion input data 1910 and the conversion supervised data 1920 is 256, respectively. Also, partial input images and partial supervised images of the size of 30×30 are cut out from the first extended learning data selected from the second learning group, for example. Thus, the number of the partial input images and partial supervised images set in the conversion input data 1910 and the conversion supervised data 1920 is 144, respectively. The present invention is not limited to this image size, and the same applies to the descriptions below.

FIG. 19A illustrates the conversion learning data 1900 generated from the extended learning data 210 having the downscaling ratio of 1. The right area of the conversion input data 1910 includes one piece of second extended learning data of the size of 512×512. The balloon of the conversion input data 1910 indicates the partial input images, and the balloon of the conversion supervised data 1920 indicates the partial supervised images corresponding to the partial input images.

FIG. 19B illustrates the conversion learning data 1900 generated from the extended learning data 210 having the downscaling ratio of 1/2. The right area of the conversion input data 1910 includes four pieces of second extended learning data of the size of 256×256.

FIG. 19C illustrates the conversion learning data 1900 generated from the extended learning data 210 having the downscaling ratio of 1/4. The right area of the conversion input data 1910 includes 16 pieces of second extended learning data of the size of 128×128.

FIG. 19D illustrates the conversion learning data 1900 generated from the extended learning data 210 having the downscaling ratio of 1/8. The right area of the conversion input data 1910 includes 64 pieces of second extended learning data of the size of 64×64.

FIG. 19E illustrates the conversion learning data 1900 generated from the extended learning data 210 having the downscaling ratio of 1/1.4. The right area of the conversion input data 1910 includes one piece of second extended learning data of the size of 360×360.

FIG. 19F illustrates the conversion learning data 1900 generated from the extended learning data 210 having the downscaling ratio of 1/2.8. The right area of the conversion input data 1910 includes four pieces of second extended learning data of the size of 180×180.

FIG. 19G illustrates the conversion learning data 1900 generated from the extended learning data 210 having the downscaling ratio of 1/5.6. The right area of the conversion input data 1910 includes 16 pieces of second extended learning data of the size of 90×90.

According to Embodiment 2, by generating the learning data with the adjusted data format, it is possible to perform a learning process using images of different data sizes rapidly and efficiently.

### Embodiment 3

Embodiment 3 differs from Embodiment 1 in processes performed by the learning unit 111 and the image processing unit 112. Embodiment 3 will be explained below mainly focusing on the differences from Embodiment 1.

The configuration of the computer 100 of Embodiment 3 is the same as that of Embodiment 1, and therefore, the explanation is omitted. The configuration of the CNN 200 of Embodiment 3 is the same as that of Embodiment 1, and therefore, the explanation is omitted.

The learning unit 111 of Embodiment 3 performs a learning process using the learning data 121, skipping the first data conversion process.

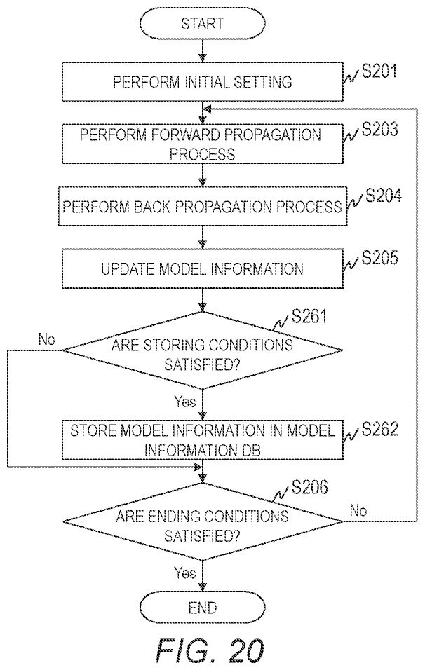

FIG. 20 is a flowchart for describing the learning process performed by the learning unit 111 of Embodiment 3.

In Embodiment 3, the learning unit 111 has a counter to manage the number of learnings (number of generations). The storing conditions indicating the timing at which the current model information 131 is to be stored in the model information DB 130 are set in advance. A possible example thereof is to store the model information 131 for every 400 generations. There are no limitations on the storing conditions in the present invention.

Because the first data conversion process is omitted, input data is not set. Thus, Step S202 and Step S207 are not performed.

In Step S205, the learning unit 111 updates the counter. Thereafter, the learning unit 111 determines whether the storing conditions are satisfied or not based on the counter value (Step S261).

In a case where the storing conditions are determined to be not satisfied, the learning unit 111 proceeds to Step S206.

In a case where the storing conditions are determined to be satisfied, the learning unit 111 stores the model information 131 updated in Step S205 in the model information DB 130 (Step S262). Thereafter, the learning unit 111 proceeds to Step S206.

As described above, the model information DB 130 of Embodiment 3 stores therein the model information 131 of different generations.

The image processing unit 112 of Embodiment 3 does not perform the second data conversion process and the third data conversion process. In Embodiment 3, the detection process is performed on the evaluation data 220.

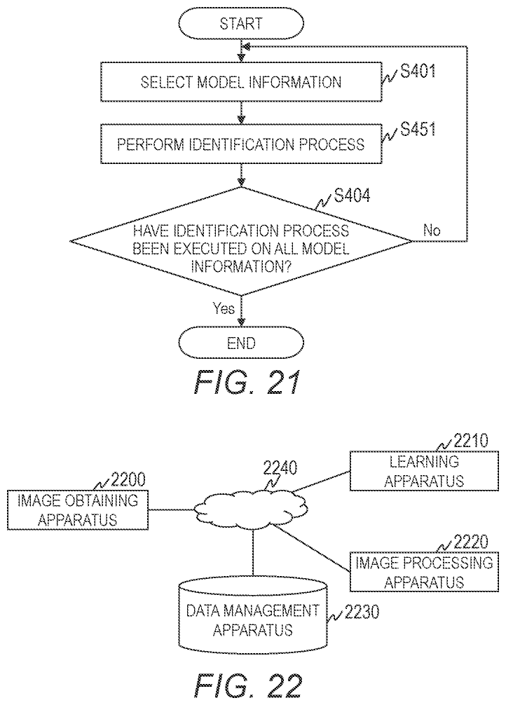

FIG. 21 is a flowchart for describing the detection process performed by the image processing unit 112 of Embodiment 3.

The image processing unit 112 selects target model information 131 from the model information DB 130 (Step S401).

Next, the image processing unit 112 performs the identification process on the evaluation data 220 based on the target model information 131 (Step S451). As a result, the output data 240 is generated.

Next, the image processing unit 112 determines whether the identification process corresponding to all the model information 131 stored in the model information DB 130 has been completed or not (Step S404).

In a case where the identification process for all of the model information 131 stored in the model information DB 130 has not been completed, the image processing unit 112 returns to Step S401, and repeats the same process.

In a case where the identification process for all of the model information 131 stored in the model information DB 130 has been completed, the image processing unit 112 ends the detection process.

The integration process of Embodiment 3 is the same as that of Embodiment 1.

According to Embodiment 3, the results output from a plurality of CNNs 200 that have received the evaluation data 220 are integrated, which makes it possible to realize image processing with a higher detection accuracy for TP-ROI 351 and a lower detection rate for FP-ROI 352.

### Embodiment 4

In Embodiment 4, a system to realize the learning of CNN 200 and the detection of nodules included in the evaluation data 220, which were described in Embodiments 1, 2, and 3, will be explained.

FIG. 22 is a diagram illustrating a system configuration example of Embodiment 4.

The system is constituted of an image obtaining apparatus 2200, a learning apparatus 2210, an image processing apparatus 2220, and a data management apparatus 2230. The respective apparatuses are connected to each other via a network 2240.

The image obtaining apparatus 2200 is an apparatus that obtains images. The images obtained by the image obtaining apparatus 2200 are used for the learning data 121 or the evaluation data 220. Examples of the image obtaining apparatus 2200 include medical apparatus such as a CT apparatus, a fluoroscopic imaging apparatus, an MRI apparatus, and an ultrasound probe, a surveillance camera, a video camera, a digital camera, a smartphone, and the like.

The learning apparatus 2210 has a function corresponding to the learning unit 111, and performs the learning process of the CNN 200. The image processing apparatus 2220 has a function corresponding to the image processing unit 112, and performs image processing using input images.

The learning apparatus 2210 and the image processing apparatus 2220 can be realized using general-purpose computers.

The data management apparatus 2230 manages the learning data 121, the evaluation data 220, the integrated output data 250, the model information 131, and the like. The data management apparatus 2230 can be realized using a storage system having a plurality of storage medium, for example. The data management apparatus 2230 can read data, store data, and the like according to instructions input from outside.

The learning apparatus 2210 and the image processing apparatus 2220 may be integrated into one apparatus.

The processes performed by each apparatus are the same as those described in Embodiments 1, 2, and 3, and thus the descriptions thereof are omitted.

The present invention is not limited to the above embodiment and includes various modification examples. In addition, for example, the configurations of the above embodiment are described in detail so as to describe the present invention comprehensibly. The present invention is not necessarily limited to the embodiment that is provided with all of the configurations described. In addition, a part of each configuration of the embodiment may be removed, substituted, or added to other configurations.

A part or the entirety of each of the above configurations, functions, processing units, processing means, and the like may be realized by hardware, such as by designing integrated circuits therefor. In addition, the present invention can be realized by program codes of software that realizes the functions of the embodiment. In this case, a storage medium on which the program codes are recorded is provided to a computer, and a CPU that the computer is provided with reads the program codes stored on the storage medium. In this case, the program codes read from the storage medium realize the functions of the above embodiment, and the program codes and the storage medium storing the program codes constitute the present invention. Examples of such a storage medium used for supplying program codes include a flexible disk, a CD-ROM, a DVD-ROM, a hard disk, a solid state drive (SSD), an optical disc, a magneto-optical disc, a CD-R, a magnetic tape, a non-volatile memory card, and a ROM.

The program codes that realize the functions written in the present embodiment can be implemented by a wide range of programming and scripting languages such as assembler, C/C++, Perl, shell scripts, PHP, Python and Java

It may also be possible that the program codes of the software that realizes the functions of the embodiment are stored on storing means such as a hard disk or a memory of the computer or on a storage medium such as a CD-RW or a CD-R by distributing the program codes through a network and that the CPU that the computer is provided with reads and executes the program codes stored on the storing means or on the storage medium.

In the above embodiment, only control lines and information lines that are considered as necessary for description are illustrated, and all the control lines and information lines of a product are not necessarily illustrated. All of the configurations of the embodiment may be connected to each other.

What is claimed is:

1. A computer configured to perform image processing to detect an object from an image, comprising:
an arithmetic device; and
a storage device coupled to the arithmetic device,
having a model information database to store a plurality of pieces of model information, model information defines a model to realize the image processing, and
the arithmetic device being configured to:
perform an identification process to detect the object from an evaluation image based on each of the plurality of pieces of model information in a case where the evaluation image is input; and
integrate a plurality of output results each of which obtained by the identification process based on each of the plurality of pieces of model information, thereby outputting a detection result of the object.

2. The computer according to claim 1,
wherein the arithmetic device is configured to integrate the plurality of output results by performing a first logical operation for performing a logical product operation on the plurality of output results and a second logical operation for performing a logical sum operation on the plurality of output results.

3. The computer according to claim 2,
wherein the model information is information to define a model to detect the object of a given size, and
wherein the arithmetic device is configured to:
generate an extended evaluation image by downscaling the size of the evaluation image to a given size; and
perform the identification process on the extended evaluation image based on at least one of the plurality of pieces of the model information.

4. The computer according to claim 3,
wherein the arithmetic device is configured to generate a plurality of pieces of extended evaluation images of different sizes from one evaluation image.

5. The computer according to claim 2, further having a learning data database to store a plurality of pieces of learning data to be used for a learning process to generate the model information,
wherein the arithmetic device is configured to:
generate a plurality of pieces of extended learning data by downscaling each of the plurality of pieces of learning data to a given size;
set a plurality of groups of extended learning data, a group includes the plurality of pieces of extended learning data each of which generated from the plurality of pieces of learning data;
generate, for each of the plurality of groups, the model information by performing a learning process using the plurality of pieces of extended learning data included in the group; and
store the generated model information in the model information database.

6. The computer according to claim 5,
wherein the arithmetic device is configured to:
select the extended learning data including the object and generate a partial image of a prescribed size including the object from the selected extended learning data;
generate conversion learning data constituted of a plurality of the partial images and at least one piece of extended learning data that does not include the object; and
perform a learning process using the conversion learning data.

7. The computer according to claim 2, further having a learning data database to store a plurality of pieces of learning data to be used for a learning process to generate the model information,
wherein the arithmetic device is configured to:
generate the model information in an initial state;
update the model information by repeating a learning process using the plurality of pieces of learning data until an ending condition is satisfied;
determine whether a storing condition for the model information is satisfied; and
store the model information with a value indicating a number of executions of the learning process in the learning data database in a case where the storing condition for the model information is satisfied.

8. An image processing method executed by a computer to detect an object from an image, the computer including an arithmetic device, and a storage device coupled to the arithmetic device, having a model information database to store a plurality of pieces of model information, model information defines a model to realize the image processing,
the image processing method including:
a first step of performing, by the arithmetic device, an identification process to detect the object from an evaluation image based on each of the plurality of pieces of model information in a case of inputting the evaluation image; and
a second step of integrating, by the arithmetic device, a plurality of output results each of which obtained by the identification process based on each of the plurality of pieces of model information, thereby outputting a detection result of the object.

9. The image processing method according to claim 8,
wherein the second step includes a step of integrating, by the arithmetic device, the plurality of output results by performing a first logical operation for performing a logical product operation on the plurality of output results and a second logical operation for performing a logical sum operation on the plurality of output results.

10. The image processing method according to claim 9,
wherein the model information is information to define a model to detect the object of a given size, and
wherein the first step includes:
a third step of generating, by the arithmetic device, an extended evaluation image by downscaling the size of the evaluation image to a given size; and
a fourth step of performing, by the arithmetic device, the identification process on the extended evaluation image based on at least one of the plurality of pieces of the model information.

11. The image processing method according to claim 10,
wherein the third step includes a step of generating, by the arithmetic device, a plurality of extended evaluation images of different sizes from one evaluation image.

12. The image processing method according to claim 9,
wherein the computer further has a learning data database to store a plurality of pieces of learning data to be used for a learning process to generate the model information, and
wherein the image processing method further includes:
a fifth step of generating, by the arithmetic device, a plurality of pieces of extended learning data by downscaling each of the plurality of learning data to a given size;
a sixth step of setting, by the arithmetic device, a plurality of groups of extended learning data, a group includes the plurality of pieces of extended learning data each of which generated from the plurality of pieces of learning data;
a seventh step of generating, by the arithmetic device, for each of the plurality of groups, the model information by performing a learning process using the plurality of pieces of extended learning data included in a group; and
an eighth step of storing, by the arithmetic device, the generated model information in the model information database.

13. The image processing method according to claim 12,
wherein the seventh step includes:
a step of selecting, by the arithmetic device, the extended learning data including the object and generating a partial image of a prescribed size including the object from the selected extended learning data;
a step of generating, by the arithmetic device, conversion learning data constituted of a plurality of the partial images and at least one piece of extended learning data that does not include the object; and
a step of performing, by the arithmetic device, a learning process using the conversion learning data.

14. The image processing method according to claim 9,
wherein the computer further has a learning data database to store a plurality of pieces of learning data to be used for a learning process to generate the model information,
wherein the image processing method further includes:
a step of generating, by the arithmetic device, the model information in an initial state;
a step of updating, by the arithmetic device, the model information by repeating a learning process using the plurality of pieces of learning data until an ending condition is satisfied;
a step of determining, by the arithmetic device, whether a storing condition for the model information is satisfied; and
a step of storing, by the arithmetic device, the model information with a value indicating a number of executions of the learning process in the learning data database in a case where the storing condition for the model information is satisfied.
